(19) United States
(12) Patent Application Publication
(10) Pub. No.: US 2015/0332355 A1
(43) Pub. Date: Nov. 19, 2015

(54) ASSET ESTIMATE GENERATION SYSTEM

(71) Applicant: Symbility Solutions Inc., Toronto (CA)

(72) Inventors: Jonathan E. Kost, Waterford, WI (US); Pascal Begin, Saint-Charles Borromee (CA); Luc Ducas, Longueuil (CA)

(21) Appl. No.: 14/713,400

(22) Filed: May 15, 2015

Related U.S. Application Data
(60) Provisional application No. 61/994,754, filed on May 16, 2014.

(51) Int. Cl. G06Q 30/02

(52) U.S. Cl. CPC G06Q 30/0283

(57) ABSTRACT

A method and apparatus for generating an asset estimate comprises presenting an initial input request for gathering asset information, receiving responses to the input request, using machine logic to automatically select one of a plurality of asset information gathering data acquisition modes based on the responses, automatically presenting the selected asset information gathering data acquisition mode and generating an asset estimate based at least in part upon asset information acquired using the selected asset information gathering data acquisition mode.

### CROSS-REFERENCE TO RELATED APPLICATIONS

This application claims the benefit of U.S. Provisional Patent Application Ser. No. 61/994,754, filed May 16, 2014, and entitled “ASSET ESTIMATE GENERATION SYSTEM,” which is hereby incorporated by reference.

### BACKGROUND

Estimates are generated for a variety of different uses such as estimating the cost to repair a damaged asset such as an automobile, boat, or real estate property (such as with an insurance claim) or estimating the value of an asset for insurance underwriting purposes. The gathering of asset information to generate an estimate is sometimes performed over the phone while at other times an agent or field representative is sent on-site. The on-site gathering of information by a field representative is time-consuming, inconvenient and expensive. On the other hand, over the phone gathering of information may be difficult and may yield unreliable or incomplete information.

### BRIEF DESCRIPTION OF THE DRAWINGS

FIG. 1 is a schematic diagram of an example asset estimate generation system.

FIG. 2 is a flow diagram of an example method for generating an asset estimate.

FIG. 3 is a schematic diagram of an example data acquisition mode selection module of the system of FIG. 1.

FIG. 4 is a flow diagram of an example method for selecting a data acquisition mode.

FIG. 5 is a flow diagram of another example method for selecting a data acquisition mode.

FIG. 6 is a schematic diagram of another example asset estimate generation system.

FIG. 7 is an illustration of an example screenshot of a display of a data acquisition mode comprising an asset sensing/image capture guide.

### DETAILED DESCRIPTION OF THE EXAMPLE EMBODIMENTS

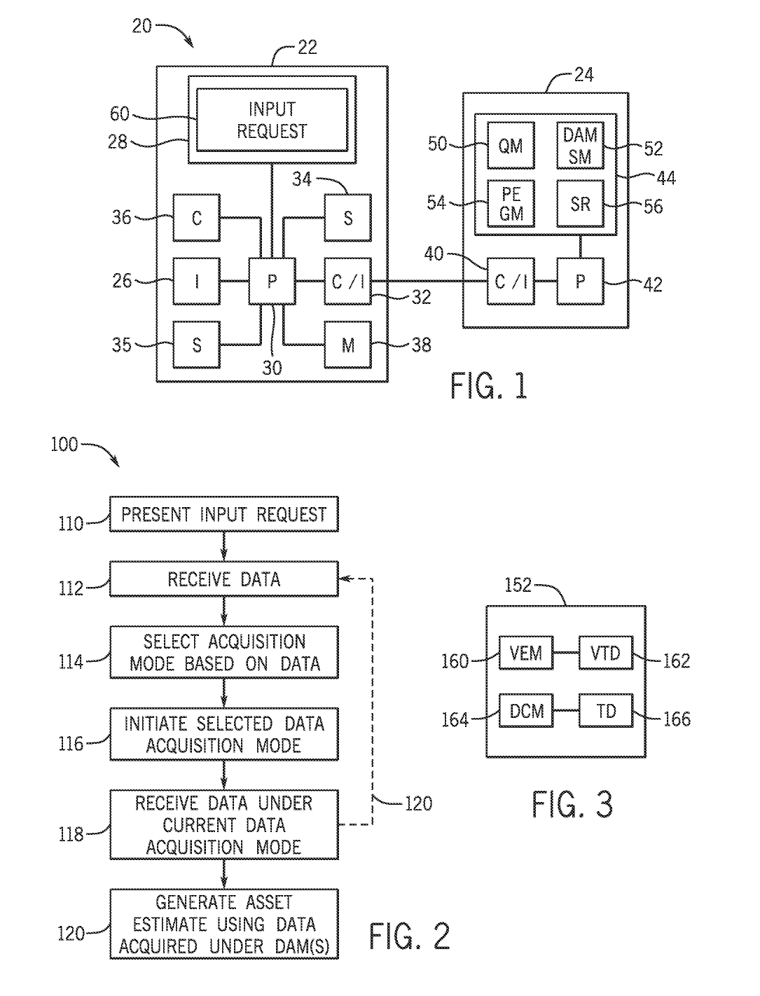

FIG. 1 schematically illustrates an example asset estimate generation system 20. As will be described hereafter, asset estimate generation system 20 can automatically select and provide an appropriate mode for data acquisition providing an appropriate level of guidance and/or control regarding the gathering of information to facilitate the generation of an estimate. Asset estimate generation system 20 automatically provides enhanced information gathering guidance and control when needed to facilitate reliable and accurate asset estimates. Asset estimate generation system 20 automatically adjusts the amount of guidance provided to a person preparing the estimate based upon various factors such as the value of the property asset or other asset as well as the circumstances regarding the estimate. As a result, asset estimate generation 20 provides an appropriate level of guidance and control so as to facilitate cost savings. Although asset estimate generation system 20 is described with respect to an asset estimate generation system, in other implementations, asset estimate generation system 20 is applicable to the generation of estimates for other assets for remediation or underwriting.

In some embodiments, asset estimate generation system 20 can be initiated by inviting a user, e.g., an insurance policyholder, to utilize the asset estimate generation system 20. The invitation to use the asset estimate generation system 20 can be a verbal invitation during a phone conversation with a remote guide person, for example, or the invitation can be sent using an email, a text or short message service (SMS). SMS are essentially instantaneous and can be received faster than emails. While maintaining the phone conversation, the user can then start the asset estimate generation system 20, e.g., on their smart phone, by simply clicking a link sent with the email or SMS, or following instructions in a text. In some embodiments, a username and password may be required, and in other embodiments, a username and password may not be required. In some embodiments, by clicking on the link, a call or other wireless connection, e.g., a web portal, can be established automatically with a remote guide person.

Asset estimate generation system 20 comprises input interface device 22 and asset data acquisition mode control 24. Input interface device 22 comprises a device by which a person associated with the asset initiates a request for the asset estimate. In one implementation, input interface device 22 comprises a device by which a person may initiate an insurance claim. In another implementation, input interface device 22 may comprise a device by which a person may initiate a request for insurance coverage which involves an underwriting or valuation of an asset to be insured. In yet another implementation, input interface device 22 may comprise a device by which a Desk Adjuster may initiate a request for further details from a subject matter expert or a contractor, for example. In yet another implementation, input interface device 22 may comprise a device by which a contractor may initiate a consultation with a Desk Adjuster, for example. In one implementation, input interface device 22 comprises a computing device. In one implementation, input interface device 22 comprises a portable electronic device or mobile computing device that may be carried on-site, e.g., when the asset is real estate property. For example, input interface device 22 may be embodied as a smart phone, a cell phone, a tablet computer, a flash memory player, a personal data assistant, a watch or the like.

In the example illustrated, input interface device 22 comprises input 26, display 28, processor 30, input interface device memory 38, and input interface device communication interface 32. In some implementations, input interface device 22 may further comprise speaker 34, sensor 35 and an image capture device or camera 36. Input 26 comprises one or more devices by which data, input or responses may be input or otherwise provided to input interface device 22. Such data may comprise audibly spoken data which is recognized by speech recognition software, typed values or words, and/or selections of displayed options with a cursor or by touch (as with a touch screen). Examples of input 26 include, but are not limited to, a keyboard, a touchpad, a touch screen, a keypad, a stylus, a microphone and speech recognition software and the like.

Display 28 comprises one or more devices to present information to a person using the input interface device 22. Display 28 may comprise a monitor or screen. In one implementation, display 28 may comprise a touch screen, also serving as input 26. In yet another implementation, input interface device 22 comprises two separate components: a display component and an input component. With such an implementation, display 28 comprises a separate component as compared to input 26. For example, in one implementation, display 28 may comprise a wearable display, such as display provided by glasses, wherein the wearable display 28 communicates with a separate input component comprising input 26 and the remainder of input interface device 22.

Processor 30 comprises one or more processing units to follow instructions contained in memory 38 so as to control input 26 and display 28 and facilitate communication with external devices using communication interface 32. For the purposes of this application, the term “processing unit” shall mean a presently developed or future developed processing unit that executes sequences of instructions contained in a memory. Execution of the sequences of instructions causes the processing unit to perform steps such as generating control signals. The instructions may be loaded in a random access memory (RAM) for execution by the processing unit from a read only memory (ROM), a mass storage device, or some other persistent storage. In other embodiments, hard wired circuitry may be used in place of or in combination with software instructions to implement the functions described. For example, processor 30 may be embodied as part of one or more application-specific integrated circuits (ASICs). Unless specifically noted otherwise, the controller is not limited to any specific combination of hardware circuitry and software, or to any particular source for the instructions executed by the processing unit.

Communication interface 32 comprises a device facilitating communication between processor 30 of input interface device 22 and asset data acquisition mode control 24. In one implementation, communication interface 32 comprises a device to facilitate wireless communication across a wide area network, such as the Internet, Ethernet, cellular networks and/or other local or satellite-based communication. In another implementation, communication interface 32, may facilitate wired communication. In yet other implementations, communication interface 32 may comprise a port to receive a portable memory device onto which data or programs may be transferred. In some implementations, asset data acquisition mode control 24 may be provided as part of input interface device 22.

Speaker 34 comprises an audible device by which information may be conveyed to a person. Sensor 35 comprises one or more sensors to sense surrounding environmental information. In one implementation, sensor 35 is configured to sense dimensional information or other data. For example, in one implementation, sensor 35 comprises a device to emit electromagnetic radiation (infrared, ultrasound and the like) and to further sense or detect reflections of such waves whereby dimensions of a room or content of a room is determined. In yet another implementation, sensor 35 outputs electromagnetic radiation so as to sense other environmental characteristics. For example, in one implementation, sensor 35 comprises one or more sensors utilize infrared electromagnetic radiation to produce images for the detection of humidity, heat loss and the like. Image capture device or camera 36 can be a form of a sensor in which an image of a surrounding environment, such as a digital photograph of a room, building, property or other asset, is captured.

Asset data acquisition mode control 24 can automatically identify and determine an appropriate mode of data acquisition providing an appropriate level of guidance or control over the process of gathering information/responses. In the example illustrated, asset data acquisition mode control is remotely located with respect to input interface device 22, communicating with input interface device 22 across a wired or wireless connection. For example, asset data acquisition mode control 24 may be provided at a remote network server computer. In other implementations, asset data acquisition mode control may be incorporated as part of input interface device 22.

Asset data acquisition mode control 24 can comprise communication interface 40, asset data acquisition mode control processor 42 and asset data acquisition mode control memory 44. Asset data acquisition mode control communication interface 40 is similar to communication interface 32. Communication interface 40 facilitates communication between asset data acquisition mode control 24 and input interface device 22. In implementations where asset data acquisition mode control 24 is incorporated as part of input interface device 22, communication interface 40 may be omitted.

Processor 42 comprises one or more processing units connected to memory 44 so as to carry out instructions contained in memory 44. Memory 44 can comprise a non-transitory computer-readable medium containing machine logic. In one implementation, memory 44 comprises computer-readable programming or code. In another implementation, memory 44 is incorporated as part of processor 42 in the form of an integrated circuit. Memory 44 can comprise input request module 50, data acquisition mode selection module 52, cost estimate generation module 54 and session recorder 56.

Input request module 50 can comprise machine logic to processor 42 to present a low level, guidance limited input request 60 to a person utilizing input interface device 22. Input request 60 can comprise a scripted or predefined request for input, generally without the assistance of live human interaction. Examples of input request 60 include, but are not limited to, a scripted questionnaire, one or more predefined fields for input or a set of instructions for the person to provide requested input. In the example illustrated, input request module 50 directs processor 42 to input request 60 to input interface device 22, wherein processor 30 displays input request 60 on display 28. The person using input interface device 22 may then enter responses through a microphone input, a touch screen input, a touchpad input, keyboard input, a cursor input, a sensor or the like. In another implementation, input request module 50 may direct processor 42 to communicate input request input request 60 to input interface device 22 for presentation in an auditory form, such as through speaker 34 of input interface device 22, wherein the person using input interface device 22 may respond audibly or may respond through input 26 using touch screen input, touchpad input, keyboard input, cursor input or the like.

Data acquisition mode selection module 52 can comprise machine logic, contained in or as part of memory 44, which directs processor 42 to determine and identify which of a plurality of available data acquisition modes are to be employed. In one implementation, data acquisition mode selection module 52 identifies those data acquisition modes that are to be utilized at a particular site or for a particular estimate project, wherein different data acquisition modes may be utilized at different sites or for different estimate projects. In one implementation, data acquisition mode selection module 52 identifies and determines different data acquisition mode to utilize for different aspects of data acquisition at an individual site or for an individual estimate project. For example, data acquisition mode selection module 52 may identify a first data acquisition mode to be utilized for the gathering of a first portion of the overall data acquisition and a second different data acquisition mode to be utilized for gathering of a second portion of the overall data acquisition for an estimate. In one implementation, data acquisition mode selection module 52 recommends to the person using input interface device 22 those data acquisition modes that have been identified. In another implementation, data acquisition mode selection module 52 automatically switches input interface device 22 to an identified data acquisition mode.

Different data acquisition modes can include different levels of information input guidance. Examples of different levels of guidance include, but are not limited to: (1) providing a scripted questionnaire or input fields for data input by a person at input interface device 22; (2) providing the person at input interface device 22 with an interface for sending an email or other message to a help center or remote guide for assistance; (3) providing a local area network or wide area network online chat input interface device 22, wherein the person at input interface device 22 and a remote guidance source alternately send and receive text messages; (4) providing the person at input interface device 22 with a live phone and/or video communication with a remote guide person; (5) providing the person at input interface device 22 with a live phone or live video call involving multiple disciplines such as a policyholder, prospective insured, insured, contractor, appraiser); and (6) scheduling an on-site visit by an expert or agent. An agent may comprise a contractor, engineer, insurance agent, insurance estimator or appraiser, remediation specialist or the like. In each of the above levels of guidance, different levels of data verification may also be provided such as whether data being input is to be verified with a video or image capture.

Different data acquisition modes additionally include different extents of information verification. Less sensitive information may require little or no verification. More critical or more sensitive information may require greater levels of verification such as verification through the capture of video or images of the asset or site. The extent of video or image capture that is required to be varied as well. For example, in some embodiments, the capture of video may be used as a view finder to assess an asset or the environment. Once assessed, or during the assessment, images can be captured that provide greater detail for the estimate generation, and the captured images are of higher resolution and independent of the communication bandwidth.

Different data acquisition modes additionally include the use of different tools or resources for data acquisition. Some tools or resources have associated higher costs than other tools. Some tools or resources have limited availability or may not be suited at particular locations or for particular applications. Examples of different tools or resources that may be utilized as selected by data acquisition mode selection module 52, include, but are not limited to, automated interior dimensioning and modeling using image capture (such as SENSOPIA MAGIC PLAN or OCCIPITAL STRUCTURE SENSOR), automated external modeling and dimensioning through image capture or satellite capture (such as ACUVERITY, EAGLEVIEW/PICTOMETRY ROOF AND EXTERIOR REPORTS), automated mobile collaboration systems using video or image capture (such as LIBRESTREAM ONSIGHT CONNECT, FACETIME, SKYPE), automated image-based recognition for use in dimensioning, scoping and content identification (such as indirect cost allocation tool ICAT, IMOBY, GOOGLE GOGGLES). Depending upon various criteria, such as the predicted value of the estimate, weight of the information being gathered to the final estimate, scope estimate and based upon the cost and availability of such resources, data acquisition mode selection module 52 can allocate the use of such resources amongst different users at different input interface devices 22 at different sites and allocates the use of such resources amongst different types of information or types of information requests presented to a person at input interface device 22. As a result, data acquisition mode selection module 52 efficiently and cost-effectively directs the use of such resources.

In one implementation, data acquisition mode selection module 52 initially requests or receives responses to the input request 60. Based upon the received responses, data acquisition mode selection module 52 determines an appropriate mode of data acquisition providing an appropriate level of guidance or control over the acquisition of additional subsequent property information for the asset estimate. Based upon the received responses or input data, data acquisition mode selection module 52 determines if a different mode of data acquisition should be employed to gather additional property information. If a different mode of data acquisition is not determined as being beneficial or cost justified, data acquisition mode selection module 52 may maintain input interface device 22 in the unguided or unassisted questionnaire answering mode in which data is continued to be gathered using additional questions presented as part of input request 60, wherein a person completes such questions without any remote person-to-person guidance.

In other circumstances, data acquisition mode selection module 52 may determine that a higher level of guidance or control should be provided during the gathering of property information. For example, data acquisition mode selection module 52 may determine that the person should be automatically provided with a live person-to-person communication with a remote guide person. Such communication may be facilitated through the use of phone, web-based and social network communication channels, such as Face Time, Instagram and the like. In one implementation, such live person-to-person communication may comprise both video and audio. In such an implementation, the insurer may supply a video call center, automatically dispatching video calls. For example, based upon responses received from the person at input interface device 22 and/or sensed information/images received from input interface device 22, data acquisition mode selection module 52, as part of the call center, may automatically switch or transfer the person at input interface device 22 to a different remote guide person who may have expertise, experience or other qualities more suited for assisting the person at input interface device 22 with the input of information.

In one implementation, data acquisition mode selection module 52 may determine that the gathering of asset information is best achieved through image capture and the analysis of captured images, wherein the person at input interface device 22 may be provided with guidance regarding the capture of such images. In yet another implementation, possibly due to the cost and/or complexity of issues that are involved, data acquisition mode selection module 52 may determine that the gathering of information is best suited for a field agent or representative being on site. In such an implementation, data acquisition mode selection module 52 may automatically initiate the collection of information to facilitate the scheduling of an on-site visit by an agent or other person to assist in the gathering of asset information.

Because data acquisition mode selection module 52 analyzes received responses to the initial portion of input request 60 and, based upon such responses, data acquisition mode selection module 52 can automatically determine an appropriate level of guidance. For example, higher levels of guidance, such as guidance involving remote live personal or human interaction, on-site interaction, actual gathering of data by an agent or a request for more detailed information with greater levels of input verification (image capture), may be provided when needed to ensure accurate and reliable gathering of asset information and generation of cost estimates. At the same time, lower levels of guidance, such as user simply receiving and completing a scripted questionnaire on input interface device 22 or responding to an automated series of questions on a phone with little input verification may be provided when sufficient as automatically determined based upon various criteria or thresholds to reduce the cost of gathering such information for the preparation of asset estimates.

In one implementation, data acquisition mode selection module 52 automatically switches input interface device 22 between different data acquisition modes for different types of information to be acquired or different types of input requests. In one implementation, data acquisition mode selection module 52 identifies those input requests that can be satisfied by user at input interface device 22 with relatively little guidance, such as through the use of a scripted questionnaire, and identifies those input requests that are better served with higher levels of guidance, such as with the assistance of a remote guide or such as with confirmation by image capture. As a result, instead of a remote guide walking through all or a majority of the input requests with a person at input interface device 22, the remote guide may only assist the person at input interface device 22 with those input requests that are more critical or sensitive to accuracy or that may require clarification from a remote guide. Consequently, data acquisition mode selection module 52 more efficiently allocates the time and resources of the remote guides or more efficiently allocates the use of computing or processing bandwidth for image capture amongst multiple data acquisition instances with different input interface devices 22.

In one implementation, data acquisition mode selection module 52 can additionally identify and/or automatically switch between different data acquisition modes based upon a current data acquisition mode environment capabilities or limitations or other site constraints. For example, in certain circumstances, wireless communication at a particular site or at particular locations at a site may not be available. For example, wireless communication may not be available at a location in the wilderness or location inside a concrete building or basement. In circumstances where a particular mode of data acquisition utilizes or is better facilitated with wireless communication, use of the particular data acquisition mode may also not be available or recommended. In such circumstances, data acquisition mode selection module 52 can automatically recommend an alternative mode of data acquisition to the user at input interface device 22 or can automatically switch the mode of data acquisition at input interface device 22 to a data acquisition mode that does not rely upon wireless communication. For example, the input interface device 22 may be using wireless communications while a user is inside a home, but when the user walks outside the home and out of range of the wireless communications, data acquisition mode selection module 52 can automatically switch the mode of data acquisition at input interface device 22 to a data acquisition mode, e.g., cellular, that does not rely upon wireless communication. In one implementation, instead of collecting the same information using a different data acquisition mode that does not rely upon wireless communication, data acquisition mode selection module 52 can alternatively reorder questions or input requests such that those input requests which do not require wireless communication with input interface device 22 are made while input interface device 22 is out of wireless communication and that those requests for information that are better served with wireless communication with input interface device 22 are postponed until such wireless communication is available to input interface device 22.

Cost estimate generation module 54 can comprise machine logic to utilize the information gathered from the initial input request 60 and subsequently gathered under one or more selected item levels to generate an asset estimate. In one implementation, the asset estimate may be an estimate for repairing or restoring a damaged asset. In another implementation, the asset estimate may be an estimate for the value of an asset (e.g., an underwriting value of the asset such as the underwriting value for real estate or an automobile, a boat, a motorcycle, etc.), such as but not limited to facilitating a replacement cost estimate as to the cost for repairing or replacing the property in response to a future event (e.g., a peril event). Although cost estimate generation module 54 is illustrated as part of asset data acquisition mode control 24, in other implementations, cost estimate generation module 54 may be provided as part of input interface device 22 or may be provided at another remote computing site.

Session recorder 56 can also comprise machine logic to direct processor 42 to automatically record and store audio, video and other session data for the data collection session. For example, in one implementation, in circumstances where a remote guide provides a person at input interface device 22 with assistance, session recorder 56 can direct processor 42 to store the interactions between the remote guide and the person at input interface device 22. In one implementation, session recorder 56 can additionally automatically transcribe the data collection session and carry out automated analysis of the session transcript to identify possible instances of fraud, patterns and the like. In some implementations, session recorder 56 may alternatively be provided as part of input interface device 22, wherein the raw session data is stored in a memory of input interface device 22 or transmitted for remote storage, such as in memory 44, or wirelessly to a cloud memory storage, for example. The recording can be done while the remote guide is online with the person at input interface device 22, or the recording can be stored locally (e.g., memory of input interface device 22 or memory 44 of asset data acquisition mode control 24) and transferred manually or automatically to the cloud when a communication network is available.

FIG. 2 is a flow diagram illustrating an example of method 100 for generating an asset estimate. Method 100 may be carried out by asset estimate generation system 20 described above with respect to FIG. 1 or other systems. As indicated by block 110, input request module 50 causes input interface device 22 to present input request 60. As noted above, input request 60 may be presented visibly on display 28 or may alternatively be presented audibly through a speaker. Input request 60 can include questions pertaining to the characteristics and conditions of the asset for which an asset estimate is to be generated. In case of an asset estimate for a property damage claim, input request 60 can additionally include questions pertaining to the event that caused such damage to the property and the extent of such damage. In the example illustrated, only a portion of the total number of questions of input request 60 may be presented prior to asset data acquisition mode control, evaluating whether the appropriate mode of data acquisition and level of guidance are presently being provided and what data acquisition mode and level of guidance should be provided for gathering additional information.

As indicated by block 112, data acquisition mode selection module 52 receives responses to input request 60 from the person utilizing input interface device 22. Such responses may be initially unguided with the person simply entering or selecting information for responding to the questions being presented by input request 60. As indicated by block 114, based upon such responses, data acquisition mode selection module 52 can evaluate whether the amount and type of information to be gathered should continue to be gathered by or through unassisted responses to input request 60 or whether a higher level of guidance should be provided during the gathering of subsequent information. Based upon such responses, data acquisition mode selection module 52 can identify and select the appropriate data acquisition mode and level of guidance for the subsequent gathering of additional information for the asset estimate. For example, the responses received to a scripted questionnaire may reveal a particular type of claim or type of asset, a particular level of complexity, a particular estimated claim cost or property value amount, a level of detail, discrepancies indicating confusion by the person completing the questionnaire or the like for which the gathering of appropriate or required information through the mere unguided or unassisted use of a scripted questionnaire is difficult or not possible.

As indicated by block 116, upon determining the appropriate mode of data acquisition and level of guidance for the gathering of information, data acquisition mode selection module 52 can initiate the selected data acquisition mode. In one implementation, data acquisition mode selection module 52 may determine, from the generally unguided responses to input request 60 thus far received, that the unguided or unassisted use of input request 60 to gather information may be continued without interruption. In another implementation, guide level data acquisition mode selection model 52 may determine, from responses to input request 60 thus far received, that the unassisted use of input request 60 may not be appropriate and that additional guidance/assistance during the collection of information should be provided. In one implementation, data acquisition mode selection model 52 can interrupt the completion of input request 60 and recommend that the person using input interface device 22 contact a live remote guide person for providing guidance. In one implementation, data acquisition mode selection model 52 may present links or prompts upon display 28 to facilitate such contact. Such contact may be made through voice communication using a speaker 34 and/or visual communication using display 28. In one implementation, such communication may be through the use of web-based real-time communication. In such an implementation, the live remote guide person may assist the person in continuing to respond to questions of input request 60. For example, the guide person may respond to questions from the person regarding how input request 60 is to be completed or may provide clarification regarding the questions being presented by input request 60. In such an implementation, the live remote guide person may additionally and/or alternatively pose additional, possibly more detailed, questions that would not otherwise be presented by input request 60. In one implementation, the remote guide person may assume the responsibility of personally filling in responses to input request 60, utilizing communicated input from the person at input interface device 22. In some implementations, data acquisition mode selection module 52 may automatically open a visual and/or audible communication link across a network between the person at input interface device 22 and the remote guide person.

In one implementation, data acquisition mode selection module 52 may determine that the gathering of information is further best facilitated using the capture of images and the analysis of such images. This capture of images may itself be guided by data acquisition mode selection module 52 using an automated process in which instructions are visibly and/or audibly presented to a person with input interface device 22. Alternatively, the capture of images may itself be guided by data acquisition mode selection module 52 automatically providing or, at least, recommending communication with a live person-to-person remote guide person who provides instructions for the capture of images or who, at least, partially remotely controls an image capture device during the capture of such images. In one implementation, input interface device 22 can additionally comprise a compass and/or gyroscope, wherein the direction/angle at which images or sensed asset information is being acquired is transmitted to the remote expert or remote guide person to assist with such guidance from the remote guide person and to facilitate subsequent identification of the gathered information. In one implementation, data acquisition mode selection module 52 can automatically make connections across the network, download and install software on input interface device 22 and/or provide instructions or requests for use of other input devices such as use of telestration image capture and/or geocode capture. With telestration image capture, data acquisition mode selection module 52 instructs the person to add telestrations, such as identifying or explanatory marks, drawings, annotations or comments on top of a captured photograph or video. With geocode or geo-reference capture, location information is captured. Such information may facilitate analysis for enhanced estimate generation or may prevent fraud. In yet another implementation, data acquisition mode selection module 52 may prompt for information to facilitate and schedule an on-site visit by an expert or agent to the property for gathering information from which an estimate for the property is to be generated.

As indicated by block 118, cost estimate generation module 54 receives the responses or input under the current or ongoing data acquisition mode, whether it be unguided or remotely guided responses to questions of input request 60, remotely guided or unguided responses in the form of captured images, or responses/information gathering in the presence of and with the assistance of an on-site expert or field agent. As indicated by broken line 120, in one implementation, data acquisition mode selection module 52 can continuously or periodically evaluate the appropriateness of the current data acquisition mode and level of guidance being provided to the person at input interface device 22 during the receipt of or gathering of information for the asset estimate. After each new piece of data or information is received or after a group or set of data or information is received, data acquisition mode selection module 52 can automatically evaluate the current data acquisition mode and level of guidance being provided during the acquisition of information with respect to presently known characteristics of the asset estimate. During the acquisition of information from a person using input interface device 22, the characteristics of the asset estimate, such as its level of complexity, estimated value or cost, type of property damage claim or the like may change such that a different level of guidance would better serve the circumstance. This may result in data acquisition mode selection module 52 automatically changing the current data acquisition mode being provided to a different data acquisition mode. For example, one or more pieces of acquired information may indicate an asset estimate to be more complex than initially expected, resulting in data acquisition mode selection module 52 outputting, recommending or automatically switching to a different data acquisition mode offering a higher level of guidance during the acquisition of information. Alternatively, one more piece of acquired information may indicate an asset to be less complex or have a lower value than previously expected, resulting in data acquisition mode selection module 52 switching to a different data acquisition mode providing a lower level of guidance during the subsequent acquisition of information. For example, data acquisition mode selection module 52, during the receipt of information, may determine that live person-to-person remote guidance is no longer required, switching to a mode in which data is acquired by the person at input interface device 22 by independently completing input request 60 once again.

In one implementation, data acquisition mode selection module 52 may automatically recommend or switch between different levels of guidance or data acquisition modes based upon an analysis of the type or complexity of data to be acquired. For example, an asset estimate may involve gathering different types of data for different aspects regarding a property. Depending upon the aspect for which data is being acquired, data acquisition mode selection module 52 may switch between different data acquisition modes. For example, for questions pertaining to a first aspect of a property, for which there is a lower likelihood of user error or for which incorrect information may be less harmful, data acquisition mode selection module 52 may output signals initiating a first data acquisition mode in which information will be acquired using unguided responses to input request 60, such as a scripted questionnaire. For questions that pertain to a second different aspect of the property, for which there is a greater likelihood of user error or for which incorrect information may have a greater impact upon the asset estimate, data acquisition mode selection module 52 may automatically recommend or switch to a different data acquisition mode offering a higher level of guidance, such as remote person-to-person communication. Upon receiving a response to the final question regarding the first aspect of the property and just before receiving information regarding the second aspect of the property, data acquisition mode selection module 52 may automatically recommend or suggest a different data acquisition mode providing a new higher level of control over data acquisition. As a result, asset data acquisition mode control 24 may provide different levels of data acquisition control and guidance for different sets or types or characteristics of property data being acquired for the asset estimate to most efficiently acquire the data while maintaining accuracy of the asset estimate. As indicated by step 120, the cost estimate generation module generates an asset estimate utilizing the data or information acquired under the one or more data acquisition modes.

FIG. 3 schematically illustrates an embodiment of a data acquisition mode selection module 152, one example implementation of data acquisition mode selection module 52. Data acquisition mode selection module 152 may be embodied as software code for being read by a processing unit or as an application-specific integrated circuit. Data acquisition mode selection module 152 determines an appropriateness of a current data acquisition mode being utilized to gather information for generation of an asset estimate and selects a data acquisition mode from a plurality of available data acquisition modes for subsequent use in gathering information for the asset estimate. In one implementation, data acquisition mode selection module 152 presents a recommendation or suggestion for switching to an alternative data acquisition mode. In another implementation, data acquisition mode selection module 152 automatically switches to the alternative selected data acquisition mode.

In the example illustrated, data acquisition mode selection module 152 can evaluate the appropriateness of the current data acquisition mode being used based upon an estimated cost or value of the asset estimate and/or based upon the responses themselves. Data acquisition mode selection module 152 can comprise value estimation module 160, value threshold database 162, data comparison module 164 and trigger database 166. Value estimation module 160 comprises machine logic to estimate, determine or predict the amount or value of an asset estimate (e.g., a property damage claim or an underwriting value) based upon data thus far received from input interface device 22 or acquired from other remote sources. In one implementation, value estimation module 160 can determine a current or interim asset estimate value after each response is inputted for each question of input request 60. In one implementation, value estimation module 160 can determine the interim asset estimate value at predetermined points in the initial input request 60 or after a predetermined set of questions of the input request 60 have been completed. When undergoing the dynamic continuous data acquisition mode evaluation represented by broken line 120 in FIG. 2, value estimation module 160 may determine the interim asset estimate value based upon what information has thus far been received regardless of what data acquisition mode under which the information has been received.

Value threshold database 162 can comprise a database or other memory for storing predefined value thresholds for triggering the use of particular data acquisition modes. For example, if an asset estimate is predicted to have a value lower than a first minimum value threshold, such as when the asset estimate is for a lower value property damage claim, data acquisition mode selection module 152 may select a data acquisition mode providing little or no additional guidance, such as a data acquisition mode in which data is acquired by requesting that a user continue to fill in blanks or complete responses to additional questions of input request 60. By way of contrast, if an asset estimate is predicted to have a value higher than the first minimum value threshold, such as for higher property damage claim, data acquisition mode selection module 152 may select a data acquisition mode providing a higher level of guidance, direction or control, such as a data acquisition mode which offers live or real-time guidance or collaboration with a remote guide person or a mode in which additional information is gathered through image capture. In yet other circumstances, if an asset estimate is projected to have a value higher than a predefined maximum value threshold, data acquisition mode selection module 152 may recommend or automatically switch to a data acquisition mode in which data is acquired through the use of an on-site visit to the property by an agent, expert or other representative.

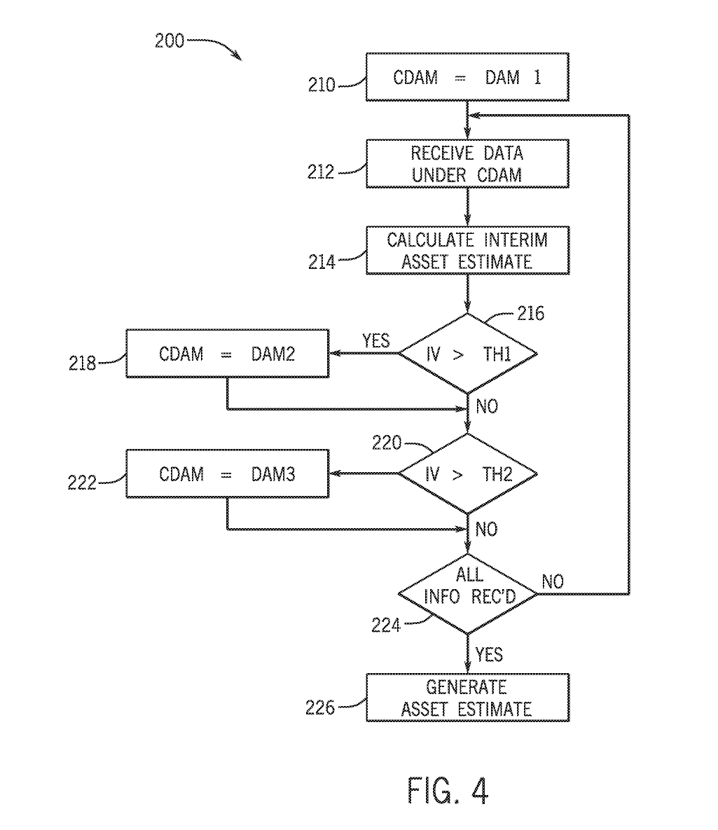

FIG. 4 is a flow diagram of an example of method 200 that may be carried out by value estimation module 160 of data acquisition mode selection module 152. As indicated by block 210, the current data acquisition mode (CDAM) for use is initially defaulted to data acquisition mode (DAM) 1. In one implementation, DAM 1 can comprise a mode of data acquisition in which a person is presented with questions from a questionnaire, visibly and/or audibly, wherein the person is prompted to complete such questions without external guidance, assistance or control

As indicated by block 212, value estimation module 160 receives the answers, responses or the other input provided at input interface device 22 under DAM 1. As indicated by block 214, value estimation module 160 can calculate an interim asset estimate/prediction based upon one or more responses received under DAM 1. In one implementation in which DAM 1 comprises questions of input request 60, value estimation module 160 can repeatedly update the asset estimate/prediction after each response to each question of input request, e.g., questionnaire 60. In another implementation in which DAM 1 comprises questions of input request 60, value estimation module 160 can determine the asset estimate/prediction after a predetermined set of questions or criterion have been answered or after all the questions of an initial portion of questions of questionnaire 60 have been answered.

As indicated by block 216, value estimation module 160 compares the interim value (IV) to a first triggering threshold TH1. As indicated by block 218, if the interim asset estimate value is greater than the first triggering threshold, value estimation module 160 automatically switches the current data acquisition mode (CDAM) to DAM 2. In one implementation, DAM 2 can comprise a real-time or live person-to-person guidance, collaboration or communication with a remote guide person. In one implementation, the remote guide person can be available to answer a person's questions regarding how to answer or fill-in responses to questions of the input request 60. In one implementation, the remote guide person can be able to view the same input request 60 (such as on a computer screen) such that the remote guide person may take over and personally fill-in the scripted questionnaire at the remote location based upon data received from person at input interface device 22. In yet another implementation, the remote guide person can ask additional questions not found in questionnaire 60 and/or guides the person in the capture of images of the property from which information may be extracted. In one implementation, the remote guide person, through a connection with input interface device 22 or another image capture device positioned or held by the person at the asset at least partially controls input interface device 22 or the other image capture device.

As indicated by block 220, value estimation module 160 can further compare the interim asset estimate value (IV) against a second value triggering threshold TH2 which is greater than threshold TH1. As indicated by block 222, if the interim asset estimate value exceeds the second value triggering threshold TH2, value estimation module 160 can automatically switch CDAM to DAM3. In one implementation, DAM 3 can comprise an on site visit to the property by an expert, field agent or other representative. For example, where an asset damage claim is so large, a visit by an agent or expert may be justified.

As indicated by block 224, value estimation module 160 can determine whether all of the information that is needed or required for generating an asset estimate has been obtained. As indicated by block 226, if all of the information or data required for an asset estimate has been obtained, cost estimation generation module 54 (shown in FIG. 1) can generate the asset estimate. Alternatively, if additional data or information is required, asset estimate generation system 20 returns to step 212, wherein value estimation module 160 receives new data under the current data acquisition mode. This process can be repeated until all information required to generate a response has been collected and an asset estimate has been generated.

In one implementation, the switching from a lower data acquisition mode which offers less guidance or less control to a higher data acquisition mode which offers greater guidance or greater control may also result in the previous data acquired under the lower data acquisition mode being confirmed. For example, if the data acquisition mode is switched from independent completion of questionnaire 60 (DAM 1) to live guidance or collaboration with a remote guide person, the remote guide person, in some implementations, may review data (responses to questionnaire 60) previously and independently entered by the person at input interface device 22 to ensure accuracy. If the data acquisition mode is switched from independent completion of questionnaire 60 (DAM 1) or remote guided completion of questionnaire 60 (DAM 2) to on-site visit by an agent (DAM 3), the on-site agent may review and confirm the accuracy of the data previously acquired under DAM 1 and/or DAM 2. Previously entered data may be revised, corrected or replaced as needed.

Data comparison module 164 can comprise machine logic to compare data received from input interface device 22 to one or more trigger data values to determine whether the current mode being used for acquiring data should be changed, upgraded or downgraded. In one implementation, data comparison module 164 parses out keywords from received data or responses and compares such data keywords against predefined trigger keywords contained in trigger database 166. For example, a response or input may include a keyword (or group of keywords) matching a keyword (or group of keywords) in trigger database 166 associated with a particular type of asset damage which is known to be complicated or require precise information. Upon identifying such a match, data comparison module 164 may trigger the use of a data acquisition mode which provides greater guidance, control or verification during the acquisition of data for the asset estimate. In one implementation, data comparison module 164 can compare received data or responses from the initial input request 60 to trigger keywords contained in trigger database 166. When undergoing the dynamic continuous data acquisition mode evaluation represented by broken line 120 in FIG. 2, data comparison module 164 may compare received data, responses, or input to triggering data after each piece of information (or a group of related information) is received, regardless of what data acquisition mode under which the information has been received.

Trigger database 166 comprises a database of predefined trigger keywords for triggering the use of particular data acquisition modes. For example, a certain set of keywords may be associated with lower guidance levels such as DAM 1. A second set of keywords may be associated with higher guidance levels such as DAM 2 or DAM 3. In one implementation, each question of input request 60 has an associated group of keywords that trigger different data acquisition modes. In such an implementation, the same keyword may trigger different data acquisition modes depending upon which question the data keyword was input or received.

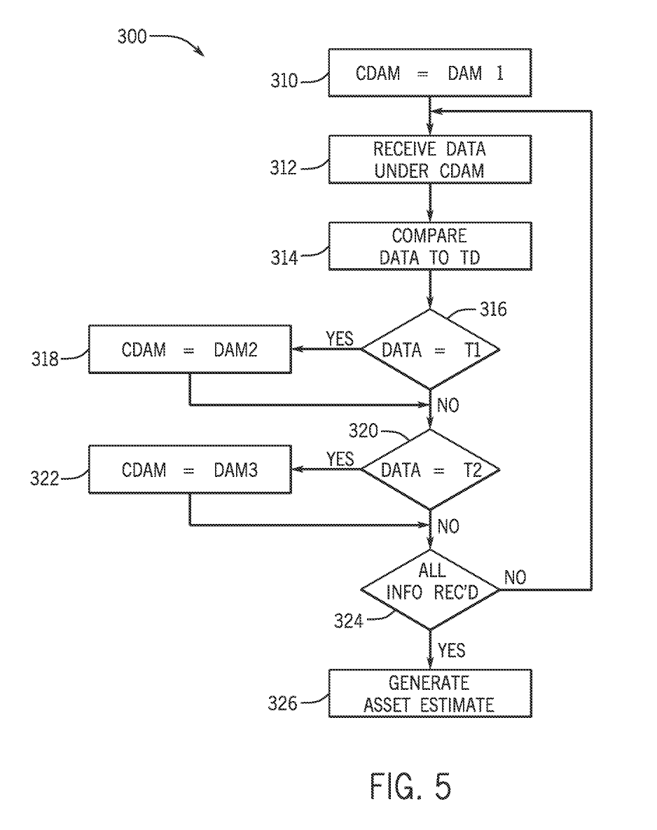

FIG. 5 is a flow diagram of an example method 300 that may be carried out by data comparison module 164 of data acquisition mode selection module 152. As indicated by block 310, the current data acquisition mode (CDAM) for use is initially defaulted to data acquisition mode (DAM) 1, with one implementation, DAM 1 can first default to a data acquisition mode in which a person is presented with questions of a questionnaire, visibly and/or audibly, wherein the person is prompted to complete such questions without external guidance or control.

As indicated by block 312, data comparison module 164 receives the answers, responses, or the other input provided at input interface device 22 under DAM 1. As indicated by block 314, data comparison module 164 compares the received data to keyword triggers contained in trigger database 166.

As indicated by block 316, data comparison module 164 can parse or identify one or more keywords in the data received in block 312 and compare the identified keyword or group of keywords to a first trigger keyword or group of keywords T1. As indicated by block 318, if identified keyword matches or sufficiently matches the predefined keyword T1 contained in trigger database 166, data comparison module 164 can automatically switch the current data acquisition mode (CDAM) to DAM 2 (described above with respect to method 200).

As indicated by block 320, data comparison module 164 can further compare the one or more keywords identified from the received data against a second trigger keyword T2. As indicated by block 322, if one or more identified keywords sufficiently match the predefined keyword T2, data comparison module 164 can automatically switch CDAM to DAM 3 (described above with respect to method 200), and can continue in this loop until resolved.

As indicated by block 324, value estimation module 160 can determine whether all of the information that is needed or required for generating an asset estimate has been obtained. As indicated by block 326, if all of the information or data required for an asset estimate has been obtained, cost estimate generation module 54 (shown in FIG. 1) generates the asset estimate. Alternatively, if additional data or information is required, asset estimate generation system 20 can return to step 312, wherein data comparison module 164 can receive new data under the current data acquisition mode. This process can be repeated until all information required to generate a response has been collected and an asset estimate has been generated. In some circumstances, the process may be suspended, temporarily stored and later restarted if not enough time is available to complete the estimate generation process in a single session. The data used to generate the asset estimate identified in block 326 may be collected over multiple sessions.

In one implementation, the switching from a lower data acquisition mode which offers less guidance or less control to a higher data acquisition mode which offers greater guidance or greater control may also result in the previous data acquired under the lower data acquisition mode being confirmed. For example, if the data acquisition mode is switched from independent completion of questionnaire 60 (DAM 1) to live guidance or collaboration with a remote guide person, the remote guide person, in some implementations, may review data (responses to questionnaire 60) previously independently entered by the person at input interface device 22 to ensure accuracy. If data acquisition mode is switched from independent completion of questionnaire 60 (DAM 1) or remote guided completion of questionnaire 60 (DAM 2) to an on-site visit by an agent (DAM 3), the on-site agent may review and confirm the accuracy of the data previously acquired under DAM 1 and/or DAM 2. Previously entered data may be revised, corrected or replaced as needed.

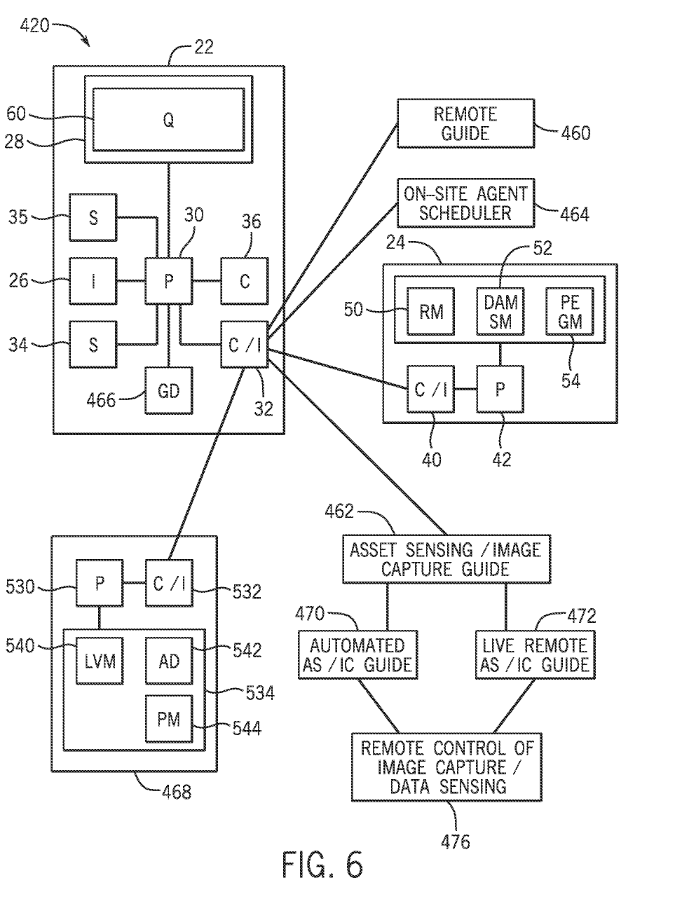

FIG. 6 schematically illustrates asset estimate generation system 420, a particular example of asset estimate generation asset estimate generation system 20 described above with respect to FIG. 1. System 420 is similar to asset estimate generation system 20 in that system 420 comprises input interface device 22 and asset data acquisition mode control 24. As shown by FIG. 6, system 420 additionally comprises remote guide 460, asset sensing/image capture guide 462, on-site agent scheduler 464, geo-referencing device 466 and input verification system 468. As with system 20, asset data acquisition mode control 24 can output a selected data acquisition mode for gathering data. The selected data acquisition mode can be based upon prior data received at input interface device 22 and analyzed by asset data acquisition mode control 24.

In a first data acquisition mode, input request module 50 of asset data acquisition mode controller 24 can direct input interface device 22 to present input request 60. The person using input interface device 22 is prompted to respond to questions of input request 60 with input data. In one implementation, the acquisition of data through input interface device 22 can continue in the first data acquisition mode until data received reveals or indicates that additional guidance or control over the acquisition of data is required. As no outside personal guidance is provided in the first data acquisition mode, there may be cost benefits to implementing the first data acquisition mode.

Upon receiving data in the first acquisition mode that indicates that additional guidance or control over the acquisition of data is needed, asset data acquisition mode control 24 either causes input interface device 22 to recommend a switch to a different data acquisition mode or automatically switches input interface device 22 to a different acquisition mode. Examples of circumstances where additional guidance or control over the acquisition of data may be needed include, but are not limited to, (1) responses to questionnaire 60 that are inconsistent or that contradict one another which indicate that the person completing questionnaire 60 may not fully understand the questions or may lack the knowledge to accurately complete questionnaire 60; (2) the value of the asset estimate (as determined by value estimation module 160) is sufficiently large enough to justify a higher level of control or guidance during the acquisition of data; and/or (3) the type of asset or the type of asset damage claim (as determined by data comparison module 164) may necessitate or be benefited by a higher level of control or guidance.

Depending upon the extent to which additional guidance or control over the acquisition of data may be beneficial, asset data acquisition mode control 24 can recommend or automatically switch to one of several different available data acquisition modes such as remote guide 460, asset sensing/image capture guide 462 or on-site agent scheduler 464. Remote guide 460 can comprise a communication hub or center by which a remote guide person interacts with the person on input interface device 22 to guide and assist the person in providing data for use in the asset estimate. In one implementation, data acquisition mode selection module 52 may present links or prompts upon display 28 to facilitate such contact. Such contact may be made through voice communication using a speaker 34 and/or visual communication using display 28. In such an implementation, the live remote guide person may assist the person in continuing to respond to questions of input request 60. For example, the guide person may respond to questions from the person regarding how input request 60 is to be completed or may provide clarification regarding the questions being presented by input request 60. In such an implementation, the live remote guide person may additionally and/or alternatively pose additional, possibly more detailed, questions that would not otherwise be presented by input request 60. In one implementation, the remote guide person may assume the responsibility of personally filling in responses to input request 60, utilizing communicated input from the person at input interface device 22. In one implementation, the remote guide 460 additionally transmits guidance illustrations or pictures to input interface device 22, wherein the guidance illustration or pictures are presented on input interface device 22 and provide examples or clarification regarding the information being requested. For example, when requesting the person at input interface device 22 to input an extent or level of damage or the quality of an asset being insured, remote guide 460 may transmit pictures illustrating examples of the different levels of damage or quality.

In one implementation, data acquisition mode selection module 52 may determine that the gathering of information is further best facilitated using a data acquisition mode involving the use of sensor 35 or the capture of images by image capture device or camera 36 and the analysis of such sensed data, images or video. Asset sensing/image capture guide 462 can guide or direct the sensing of data or the capture of such images or video. In the example shown in FIG. 6, asset sensing/image capture guide 462 is operable under one of two different modes: an automated asset sensing/image capture guide mode 470 and a live remote asset sensing/image capture guide mode 472.

In the automated asset sensing/image capture guide mode 470, asset sensing/image capture guide 462 can be automated, utilizing a processor following instructions contained in a non-transitory computer-readable medium to output signals which are transmitted to input interface device 22, wherein the signals cause input interface device 22 to present guidance or a series of instructions regarding the capture of images by input interface device 22 or a separate image capture device. The instructions may vary based upon a real-time live dynamic analysis of the image being captured. For example, asset sensing/image capture guide 462 may provide text on display 28 or auditory instructions on speaker 34 instructing the person at input interface device 22 to point his or her sensing device or camera (a static camera or a video camera) at a particular region or portion of the asset for which an estimate is to be generated. Asset sensing/image capture guide 462, in the automated mode, analyzes the one or more received images. If asset sensing/image capture guide 462 determines that the captured/received images are not satisfactory, such as the captured images being out of focus, at a wrong angle or at an incorrect portion of the asset, asset sensing/image capture guide 462 may output further instructions requesting a change in the acquisition parameters of the image capture device, such as changing the positioning of the camera, changing the orientation of the camera, changing the distance of the camera from an object, changing the focus of the camera, changing the zoom of the camera, changing the lighting or the like.

While operating in the live remote asset sensing/image capture guide mode 472, asset sensing/image capture guide 462 facilitates communication between input interface device 22 and a live remote asset sensing/image capture guide person at a call center or other remote location. The communication between input interface device 22 and the live remote asset sensing/image capture guide person facilitates real-time collaboration. In other words, the guide person is able to visibly see in real time what is being captured or “seen” by the image capture device. As a result, the guide person is able to see at what object the image capture device is pointed at, the present focus of the image capture device or the lighting in which the images is being captured. The guide person is able to use real-time information to speak with the person holding the image capture device or to provide textual instructions on input interface device 22 to instruct the person holding input interface device 22 serving as the image capture device or camera 36 with regard to the capture of images of the property that best provide information for completing the asset estimate. In other words, the remote guide person may see in real time the property for which the asset estimate is to be generated and may direct the person holding the image capture device to capture particular images. In one implementation, the remote asset sensing/image capture guide person providing instruction as to the capture of images may be the same person that provides assistance in the completion of questionnaire 60 from remote guide 460. In one implementation, asset sensing/image capture guide 462 additionally transmits guidance illustrations, pictures or videos to input interface device 22, wherein the guidance illustration, pictures or videos are presented on input interface device 22 and provide examples or clarification regarding what type of images are to be captured.

In one implementation, asset sensing/image capture guide 462 is further operable in a remote control mode 476. In such a mode, the image capture device, whether be provided by a an image capture device or camera 36 associate with input interface device 22 or a separate independent camera, is configured to be at least partially remotely controlled. In such an implementation, the focus, zoom, turning on/off or other acquisition parameters of the image capture device or camera are remotely adjustable. When operating in the automated asset sensing/image capture guide mode 470, the processor, based upon an analysis of the image being captured or remotely “seen”, may cause signals to be transmitted to the image capture device automatically adjusting the acquisition parameters of the image capture device. When operating in the live remote asset sensing/image capture guide mode 472, the remote asset sensing/image capture guide person may be presented with manual controls which produce control signals that are transmitted to the image capture device to adjust the image capture device acquisition parameters. In such implementations, the person at input interface device 22 may be simply instructed to point the camera or image capture device at a general area, wherein the zoom or other characteristic of the camera are remotely adjusted to best capture a particular feature of the property within the general area.

Upon the receipt of sense data from sensor 35 or the capture of one or more images by image capture device or camera 36, whether it be under the automated asset sensing/image capture guide mode 470, the live remote asset sensing/image capture guide mode 472 or the remote control mode 476, cost estimate generation module 54 can automatically utilize such captured images. In one implementation, cost estimate generation module 54 automatically place or file the captured images in the correct spots in a claim form or other forms and reports. In one implementation, cost estimate generation module 54 can analyze the captured images and extract information from the captured images for use in generating the asset estimate. In one implementation, such extracted information can be additionally used to create a point cloud or a 3-D model with dimensions, wherein the point cloud and/or the 3-D model accompany the estimate to substantiate the estimate. In addition to facilitating the collection of structural information regarding an asset or property, the captured images can be, in some implementations, used to automatically collect information regarding the contents of the asset, such as contents within a building or the like. For example, in one implementation, such image analysis may comprise the application of a spectrum filter through certain colors to facilitate the visual identification of scratches. In one implementation, image gamma may be adjusted to reduce outdoor illumination to facilitate the identification of details.

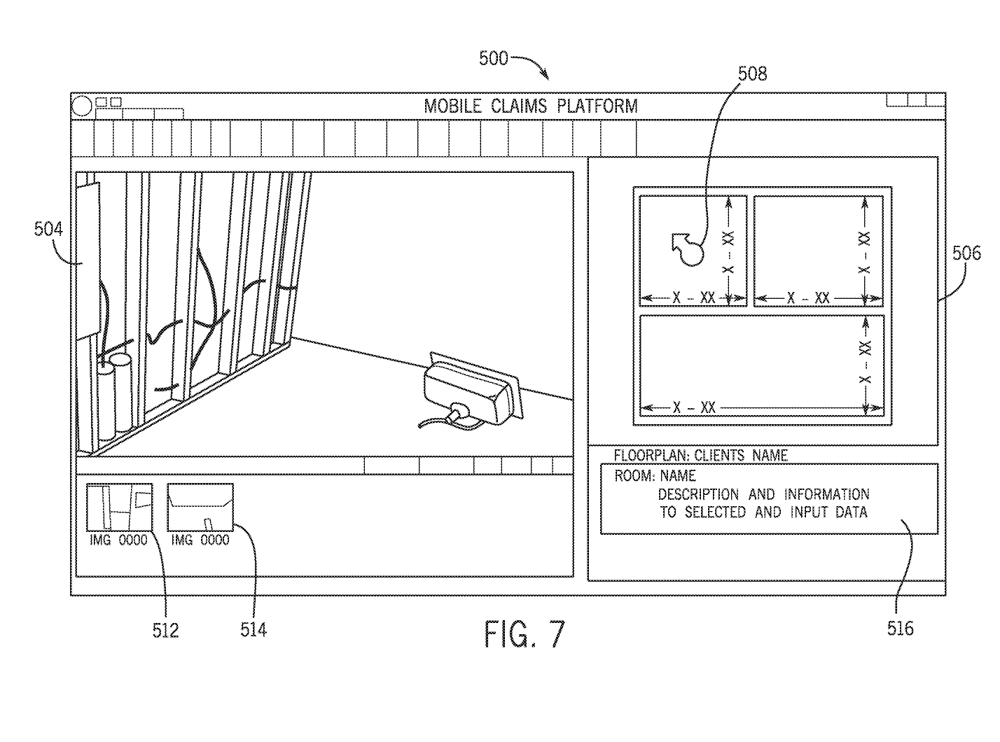

FIG. 7 illustrates an example screenshot 500 of a display screen provided to a remote asset sensing/image capture guide person by asset sensing/image capture guide 462 operating under the live remote asset sensing/image capture guide mode 472. As shown by window 504, the remote asset sensing/image capture guide person can be presented with a live video stream from sensor 35 or from the image capture device or camera 36 as positioned by the person on site on the property for which an asset estimate is to be generated. As shown by window 506, the asset sensing/image capture guide person is further presented with a current determined layout of a property such as the currently determined layout of a building. As images are captured and analyzed by image capture device, such as an image capture device or camera 36, the layout of a property or building is determined and updated. Using positional information, such as through a global positioning satellite system, the precise positioning and direction of the image capture device may be presented as indicated by icon 508. As indicated by the displayed thumb nails 512, 514 on-screen 500, individual images may be statically captured as image capture device is differently pointed within the property. In one implementation, the remote asset sensing/image capture guide person may instruct the person holding the image capture device to take a snapshot at the current positioning of the image capture device. In another implementation, the remote asset sensing/image capture guide person may remotely control sensor 35 or the image capture device or camera 36 to sense data or to take a snapshot or initiate/terminate the capturing of a video when the image capture device is currently positioned at a particular position.

In addition to acquiring video and snapshots confirming the accuracy or validity of entered data regarding a property, cost estimate generation module 54 may further analyze the required video or snapshots to extract additional information. For example, in one implementation, cost estimate generation module 54 can utilize a captured image to determine room dimensions (as shown by window 516 in screen 500 of FIG. 7), exterior building dimensions, building materials, the presence and type of fixtures, construction architecture, extent of damage and the like. By utilizing captured images (video and snapshots), system 420 facilitates a gathering of additional data regarding an asset, beyond what may be acquired simply by the guided or unguided completion of questionnaire 60. This ability to collect additional information or data regarding an asset, for which an estimate is being prepared, may reduce the number of on-site visits to assets by an expert or agent, greatly reducing the preparation costs of an asset estimate.

On-site agent scheduler 464 provides a data acquisition mode in which data is acquired by an on-site visit to the property by an expert or agent. Scheduler 464 can comprise machine logic provided as part of asset data acquisition mode control 24, input interface device 22 or at another computing site, wherein the machine logic prompts the person at input interface device 22 for information to facilitate the scheduling of the on-site visit to the property. As noted above, the on-site visit by the agent or expert provides a high level of control during the acquisition of data for use in preparing the asset estimate.

Geo-referencing device 466 comprises a device which receives signals from a global positioning system, global navigation satellite system, quantum compass, indoor positioning system or the like. An indoor positioning system, also referred to as micro mapping, comprises a network of devices to wirelessly locate objects, people or locations inside a building. In one implementation, such an indoor positioning system utilizes anchors or nodes with a known position which actively locate tags or provide ambient location or environmental context for devices to be sensed. Such implementations may utilize optical, radio or acoustic technologies to facilitate indoor tracking. In the example illustrated, geo-referencing device 466 can be incorporated as part of input interface device 22 and can output signals identifying the location of input interface device 22. In one implementation, processor 30 can track the location of input interface device 22 over time as determined based upon signals from geo-referencing device 466. Input interface device 22 can further store such track locations and can be of great use by verification system 468. In yet another implementation, processor 30 can transmit the location of input interface device 22, based upon signals from geo-referencing device 466, to remote verification system 468. In one implementation, processor 30 can store the tracked location of input interface device 22 or transmits the current location of interface device 22 to verification system 468 when information is being transmitted for estimate generation in an unalterable automatic fashion were in such location transmission or storage is not adjustable and cannot be stopped by the person using input interface device 22 when estimation functions are being carried out. In one implementation, the transmission of data preparation of an estimate can automatically require, as a prerequisite, the transmission or receipt of location data from input interface device 22. Such signals indicating the ongoing or current position of input interface device 22 facilitate further data acquisition as well as verification of the accuracy of such information.

Verification system 468 can comprise a system which verifies the accuracy of information or data received. In the example illustrated verification system 468 can comprise a remote server device comprising processor 530, communication interface 532 and memory 534. Processor 530 can comprise one or more processing units to follow instructions contained in a memory so as to verify the accuracy of information or data being received through input interface device 22 for the preparation of an estimate.

Communication interface 532 can comprise a device facilitating communication between processor 530 and input interface device 22. In one implementation, communication interface 532 can comprise a device to facilitate wireless communication across a wide area network, such as the Internet, Ethernet and/or cellular networks. In another implementation, communication interface 532 may facilitate wired communication. In yet other implementations, communication interface 532 may comprise a port to receive a portable memory device onto which data or programs may be transferred. In some implementations, verification system 468 can be part of input interface device 22, wherein the indication interface 532 can be omitted.

Memory 534 can comprise a non-transitory computer-readable medium containing machine logic, in the form of software or circuitry, to direct the operation of processor 530 and to store data. For purposes of this disclosure, the term “machine logic” comprises programmed logic and machine-learned logic. Memory 534 can comprise location verification module 540, asset database 542 and predictive module 544. Location verification module 540 can comprise machine logic which directs processor 530 to receive signals from input interface device 22 indicating the current version of input interface device 22 as estimate information is being received or stored tracked location information for input interface device 22 when such information was being input. Location verification module 540 can further direct processor 530 to retrieve information regarding the asset, such as a piece of property, for which an estimate is being generated. In one implementation, processor 530 can retrieve an identification of the asset or property for which the estimate is being generated and/or retrieves an address or location for the property from a local database, such as asset database 542 or from a remote database across a local or wide area network. Module 540 can verify information received through input interface device 22 for the estimate by comparing the time in which the information was input to input interface device 22 for the asset of interest, the location of input interface device 22 at the time that the information was input and the stored location of the asset of interest.

For example, system 420 may be collecting information for the generation of an estimate for a property at location X. During the capture of images in the collection of information, geo-referencing device 466 receive signals indicating the geo-referenced position of input interface device 22 at the time that such images are captured. Geo-reference information can be transmitted to system 468. Processor 530 can determine whether the geo-reference information regarding the location of input interface device 22 at the time of image capture corresponds to the location X of property. If the geo-referenced information regarding the location of input interface device 22 at the time of image capture does not match location of the property of interest, a fraudulent input of information may be occurring. In one implementation, processor 530 flags the discrepancy in the generated estimate. In one implementation, processor 530 can automatically connect input interface device 22 to remote guide 460 for assistance.

Predictive module 544 can comprise machine logic which directs processor 530 to retrieve information or data input through input interface device 22 and/or information retrieved from other sources, such as other local or remote property or asset records. Predictive module 544 can further direct processor 530 to utilize such retrieved information or data and prior estimate histories and/or prediction algorithms to predict expected future input through input interface device 22. For example, already input information may indicate, to a high degree of probability, a subsequent input or answer. Predictive module 544 can direct processor 530 to compare one or more inputs received through input interface device 22 to what was the predicted input based upon related information or prior input. In one implementation, in circumstances where the actual received input or information is surprising in that it does not match or substantially correlate to what was predicted, predictive module 544 can direct processor 530 to flag the unexpected input on the output estimate or to flag the unexpected input for further verification or for a possible indication of fraud. In one implementation, where the actual received input or information is surprising in that it does not match or substantially correlate to what was predicted, predictive module 544 can direct processor 530 to automatically connect the person using input interface device 22 to remote guide 460 for further enhanced guidance regarding the input of information through input interface device 22. In another implementation, where the actual received input or information is surprising in that it does not match or substantially correlate to the predicted information or input, predictive module 544 can direct processor 530 to change the mode of data acquisition so as to acquire additional confirming evidence by automatically connecting input interface device 22 to asset sensing/image capture guide 462.

Because system 420 includes verification system 468, system 420 may be more likely to identify and address possibly incorrect data input through input interface device 22. As noted above, in some implementations, system 420 can automatically switch to a different data acquisition mode, such as switching to remote guide 460 or asset sensing/image capture guide 462, in response to receiving what would appear to be inconsistent or incorrect data inputs. In yet other implementations, system 420 may omit verification system 468. Although verification system 468 is illustrated as being provided by separate computing device are separate server, in other implementations, verification system 468 may alternatively be incorporated as part of input interface device 22 or as part of asset data acquisition mode control 24. In some implementations, the location verification and the predictive verification processes described above can be implemented in separate and independent computing devices. For example, location verification (location verification module 540) may be located within input interface device 22 while predictive verification (predictive module 544) may be located on a remote server or computing device.

Although the present disclosure has been described with reference to example embodiments, workers skilled in the art will recognize that changes may be made in form and detail without departing from the spirit and scope of the claimed subject matter. For example, although different example embodiments may have been described as including one or more features providing one or more benefits, it is contemplated that the described features may be interchanged with one another or alternatively be combined with one another in the described example embodiments or in other alternative embodiments. Because the technology of the present disclosure is relatively complex, not all changes in the technology are foreseeable. The present disclosure described with reference to the example embodiments and set forth in the following claims is manifestly intended to be as broad as possible. For example, unless specifically otherwise noted, the claims reciting a single particular element also encompass a plurality of such particular elements.

What is claimed is:

1. A method for generating an asset estimate, the method comprising:
presenting an initial input request for gathering asset information;
receiving responses to the initial input request;
based on the responses, using machine logic, automatically selecting one of a plurality of asset information gathering data acquisition modes;
automatically presenting the selected asset information gathering data acquisition mode; and
generating an asset estimate based at least in part upon asset information acquired using the selected asset information gathering data acquisition mode.

2. An electronic apparatus for generating and presenting an asset estimate, the apparatus comprising:
a display;
an input;
a processing unit; and
a non-transitory computer-readable medium containing programmed logic to direct the processing unit to:
present a scripted questionnaire for gathering asset information;
receive responses to the scripted questionnaire;
based on the responses, automatically select one of a plurality of asset information gathering data acquisition modes;
automatically present the selected asset information gathering data acquisition mode; and
generate an asset estimate based at least in part upon asset information acquired using the selected asset information gathering data acquisition mode.

3. The apparatus of claim 2, wherein the plurality of asset information gathering data acquisition modes are selected from a group of asset information gathering data acquisition modes consisting of: presenting additional questions for response; initiating a live person-to-person information gathering guidance communication with a remote guide person; initiating image capture guidance; initiating asset sensing and initiating scheduling of an on-site asset information gathering by an agent.

4. The apparatus of claim 2, wherein the plurality of asset information gathering data acquisition modes from which information gathering data acquisition modes selected comprises initiating image capture guidance.

5. The apparatus of claim 4, wherein the initiating image capture guidance comprises:
instructing a person to use the portable electronic device to capture an image of a portion of the property associated with the question;
receiving the captured image of the property;
analyzing contents of the captured image, using machine logic, to extract asset information from the captured image for use in generating the asset estimate.

6. The apparatus of claim 5, wherein the instructing of the person to use the portable electronic device to capture an image of a portion of the property comprises presenting an automated image capture guidance script on the portable electronic device.

7. The apparatus of claim 6 further comprising automatically adjusting the automated image capture guidance script based upon analysis of at least one received captured image.

8. The apparatus of claim 7 further comprising automatically switching from the automated image capture guidance script on the portable electronic device to a live person-to-person image capture guidance session with a remote guide person based upon analysis of at least one received captured image.

9. The apparatus of claim 8 wherein the instructing of the person to use the portable electronic device to capture an image of a portion of the property comprises remotely controlling at least one image capture parameter.

10. The apparatus of claim 4, wherein the instructing of the person to use the portable electronic device to capture an image of a portion of the property comprises initiating a live person-to-person image capture guidance session with a remote guide person.

11. The apparatus of claim 2, wherein the automatically selecting one of a plurality of asset information gathering data acquisition modes comprises:
determining a current estimated value for the asset estimate; and
comparing the current estimated value for the asset estimate to a predefined threshold, wherein the selection of one of the plurality of information gathering data acquisition modes is based upon the comparison.

12. The apparatus of claim 2, wherein the automatically selecting one of a plurality of asset information gathering data acquisition modes comprises comparing a response to a database of responses, wherein the selection of one of the plurality of asset information gathering data acquisition modes is based upon the comparison.

13. The apparatus of claim 2 further comprising:
receiving asset information under the selected asset information gathering data acquisition mode;
automatically switching to a different one of the plurality of asset information gathering data acquisition modes based upon the asset information received under the selected asset information gathering data acquisition mode.

14. An electronic apparatus for generating an estimate for a property, the apparatus comprising:
a non-transitory computer-readable medium containing code to direct a processing unit to:
present, on a portable electric device, a first question of a scripted questionnaire regarding the property;
present, on a portable electric device, a second question of the scripted questionnaire regarding the property;
compare an input response to the second question to a predicted response based upon an input response to the first question; and
provide person-to-person real-time collaboration with the person across the portable electronic device based upon the comparison;
generating an estimate for the property based upon responses to the scripted questionnaire.

15. The apparatus of claim 14, wherein the code is further to direct the processing unit to receive a captured image of the property, where the predicted response is additionally based upon an analysis of contents of the captured image.

16. The apparatus of claim 14, wherein the person-to-person real-time collaboration comprises guidance regarding capture of an image of the property.

17. The apparatus of claim 14, wherein the person-to-person real-time collaboration comprises guidance regarding responding to a question of the scripted questionnaire.

18. The apparatus of claim 14, wherein the code is further to:
receive an image of the property captured on the portable electronic device;
analyze contents of the captured image;
automatically modify the scripted questionnaire regarding the property based upon the analyzed contents of the captured image; and
generate an estimate for the property based upon responses to the scripted questionnaire.

19. The apparatus of claim 18, wherein the code is further to direct the processing unit to:
present, on the portable electric device, a question of the scripted questionnaire regarding the property;
prompt a person to use the portable electronic device to capture the image, wherein the image is associated with the question.

20. The apparatus of claim 18, wherein automatically modifying the scripted questionnaire comprises automatically pre-filling inputs to the scripted questionnaire.

21. The apparatus of claim 18, wherein automatically modifying the scripted questionnaire comprises automatically adding questions to the scripted questionnaire.

22. The apparatus of claim 18, wherein automatically modifying the scripted questionnaire comprises automatically selecting and presenting one of a plurality of alternative branches of questions of the scripted questionnaire.

23. The apparatus of claim 18, wherein automatically modifying the scripted questionnaire comprises removing questions from the scripted questionnaire.
